(19) United States
(12) Patent Application Publication
(10) Pub. No.: US 2014/0233577 A1
(43) Pub. Date: Aug. 21, 2014

(54) COMMUNICATION SYSTEM, CONTROL APPARATUS, AND CONTROL METHOD THEREOF

(71) Applicants: Yoichi Hatano, Tokyo (JP); Yoshikazu Watanabe, Tokyo (JP)

(72) Inventors: Yoichi Hatano, Tokyo (JP); Yoshikazu Watanabe, Tokyo (JP)

(73) Assignee: NEC Corporation, Tokyo (JP)

(21) Appl. No.: 14/348,178

(22) PCT Filed: Sep. 28, 2012
(86) PCT No.: PCT/JP2012/006221

§ 371 Date: Mar. 28, 2014

(30) Foreign Application Priority Data
Sep. 29, 2011 (JP) 2011-214482

(51) Int. Cl. H04L 12/717

(52) U.S. Cl. CPC H04L 45/42
USPC 370/400

(57) ABSTRACT

A communication system includes: a plurality of nodes; a first node transmitting a request for a processing rule for processing a first packet; and a control apparatus including a first unit determining a first processing rule corresponding to the first packet in response to the request and preliminarily determining a second processing rule corresponding to a second packet that relates to the first packet and a second unit notifying the first node of the first processing rule and notifying at least one of the plurality of nodes of the second processing rule.

### CROSS-REFERENCE TO RELATED APPLICATIONS

### Field

The present invention is based upon and claims the benefit of the priority of Japanese patent application No. 2011-214482, filed on Sep. 29, 2011, the disclosure of which is incorporated herein in its entirety by reference thereto.

The present invention relates to a communication system, a control apparatus, and a control method thereof. In particular, it relates to a communication network, a communication system, a control apparatus, and a control method thereof for setting communication paths.

### Background

There is a centralized-management-type network path control technique in which a control apparatus controls packet forwarding paths via a plurality of nodes in a centralized manner. An OpenFlow technique is an example of such centralized-management-type technique.

Patent Literature (PTL) 1 discloses a centralized-management-type path control technique using an OpenFlow technique. The OpenFlow technique disclosed in PTL 1 recognizes communications as end-to-end flows and performs path control on a per-flow basis to execute load balancing and path optimization.

In PTL 1, a switch serving as a forwarding node has a secure channel for communication with a controller (control apparatus) calculating packet paths and operates according to a flow table set by the controller. The flow table defines a combination of a matching rule against which packet header information is matched and an action in which a processing content applied to a packet matching the matching rule is written. Examples of the action include a process of forwarding a packet to a certain interface.

If the switch disclosed in PTL 1 receives a packet, the switch searches the flow table for an entry having a matching rule matching header information of an incoming packet. As a result of this search, if the switch finds an entry matching the incoming packet, the switch executes a processing content (forwards the incoming packet to a certain interface, for example) written in the action field in the entry.

As a result of the search, if the switch does not find an entry matching the packet, the switch requests the controller to set an entry for the incoming packet. In response to the request, the controller calculates a path for the incoming packet and notifies the switches that relates to the calculated path of an entry for realizing forwarding using the path. After notified of such entry, each of the switches updates the flow table therein and executes a processing content written in the entry in the updated flow table. Namely, each switch forwards the incoming packet.

### CITATION LIST

### Patent Literature

### [PTL 1]

Japanese Patent Kohyo Publication No. JP2010-541426A

### SUMMARY

### Technical Problem

The entire disclosure of the above PTL 1 is incorporated herein by reference thereto. The following analyses are given by the present invention. As described above, according to the related technique disclosed in PTL 1, even if packets relate to each other, if header information differs from each other, the switch recognizes that each of the packets belongs to a different flow. Consequently, the switch requests the controller to set an entry for each of the packets that relate to each other.

In response to the request for setting an entry, the controller needs to calculate an entry for each of the packets that relate to each other. Thus, the calculation load on the controller is increased.

### Solution to Problem

According to a first aspect of the present invention, there is provided a communication system, comprising: a plurality of nodes; a first node transmitting a request for a processing rule for processing a first packet; and a control apparatus comprising a first means (unit) determining a first processing rule corresponding to the first packet in response to the request and preliminarily determining a second processing rule corresponding to a second packet that relates to the first packet and a second means (unit) notifying the first node of the first processing rule and notifying at least one of the plurality of nodes of the second processing rule.

According to a second aspect of the present invention, there is provided a control apparatus, connected to a plurality of nodes, the control apparatus comprising: a means (unit) receiving a request for a processing rule for processing a first packet from a first node; a first means (unit) determining a first processing rule corresponding to the first packet in response to the request and preliminarily determining a second processing rule corresponding to a second packet that relates to the first packet; and a second means (unit) notifying the first node of the first processing rule and notifying at least one of the plurality of nodes of the second processing rule.

According to a third aspect of the present invention, there is provided a control method, executed by a control apparatus connected to a plurality of nodes, the control method comprising steps of: receiving a request for a processing rule for processing a first packet from a first node; determining a first processing rule corresponding to the first packet in response to the request and preliminarily determining a second processing rule corresponding to a second packet that relates to the first packet; and notifying the first node of the first processing rule and notifying at least one of the plurality of nodes of the second processing rule.

### Advantageous Effects of Invention

According to the present invention, since a controller collectively calculates paths for packets that relate to each other, it contributes to a reduction of the load on the controller.

### BRIEF DESCRIPTION OF DRAWINGS

FIG. 1 illustrates a configuration of a network system according to a first exemplary embodiment.

FIG. 2 illustrates a configuration of a node according to the first exemplary embodiment.

FIG. 3 illustrates a configuration of a controller according to the first exemplary embodiment.

FIG. 4 illustrates a packet relevance table according to the first exemplary embodiment.

FIG. 5 illustrates a configuration of packet header information according to the first exemplary embodiment.

FIG. 6 illustrates an operation of a node executed when the node receives a packet according to the first exemplary embodiment.

FIG. 7 illustrates an operation of the controller executed when the controller receives a request for a flow entry according to the first exemplary embodiment.

FIG. 8 illustrates a configuration of a network system according to a second exemplary embodiment.

FIG. 9 illustrates a configuration of a controller according to the second exemplary embodiment.

FIG. 10 illustrates a configuration of a network system according to a third exemplary embodiment.

FIG. 11 illustrates an operation of a controller executed when the controller receives a request for a flow entry according to the third exemplary embodiment.

FIG. 12 illustrates a configuration of a node according to a fourth exemplary embodiment.

FIG. 13 illustrates a configuration of a controller according to the fourth exemplary embodiment.

FIG. 14 illustrates a flow entry storage unit according to the fourth exemplary embodiment.

FIG. 15 illustrates an operation of the controller executed to set a path in advance according to the fourth exemplary embodiment.

FIG. 16 illustrates an operation of the node executed when the node receives a packet according to the fourth exemplary embodiment.

FIG. 17 illustrates an operation of the controller executed when the controller receives a request according to the fourth exemplary embodiment.

### DESCRIPTION OF EMBODIMENTS

Hereinafter, exemplary embodiments will be described with reference to the drawings.

### First Exemplary Embodiment

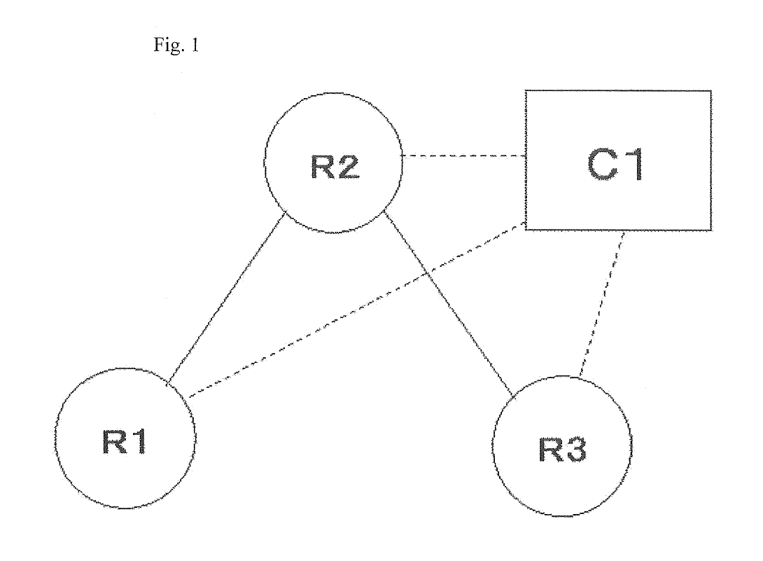

FIG. 1 illustrates a configuration of a network system according to a first exemplary embodiment.

In the first exemplary embodiment, a controller C1 controls a packet forwarding path in response to a request from at least one of a plurality of nodes R1 to R3. As described above, the OpenFlow technique is an example of such centralized-management-type technique. To realize the network system, the OpenFlow technique may be applied. The following exemplary embodiment will be described assuming that the OpenFlow technique is applied to the network system. The network system according to the first exemplary embodiment can be realized, as long as the controller (path control apparatus) controls a packet forwarding path via a plurality of nodes in a centralized manner. Namely, the network system is not limited to use of the OpenFlow technique.

As illustrated in FIG. 1, the network system according to the first exemplary embodiment includes the nodes R1 to R3 that execute packet forwarding. In addition, the network system includes the controller C1 that controls a packet forwarding path in response to a request from at least one of the nodes R1 to R3.

To communicate with the controller C1, each of the nodes R1 to R3 establishes a communication channel in which security between the node and the controller C1 is ensured (dotted lines in FIG. 1). In addition, each of the nodes R1 to R3 processes an incoming packet in accordance with a processing rule (hereinafter, referred to as “flow entry”) suitably added or rewritten by the controller C1.

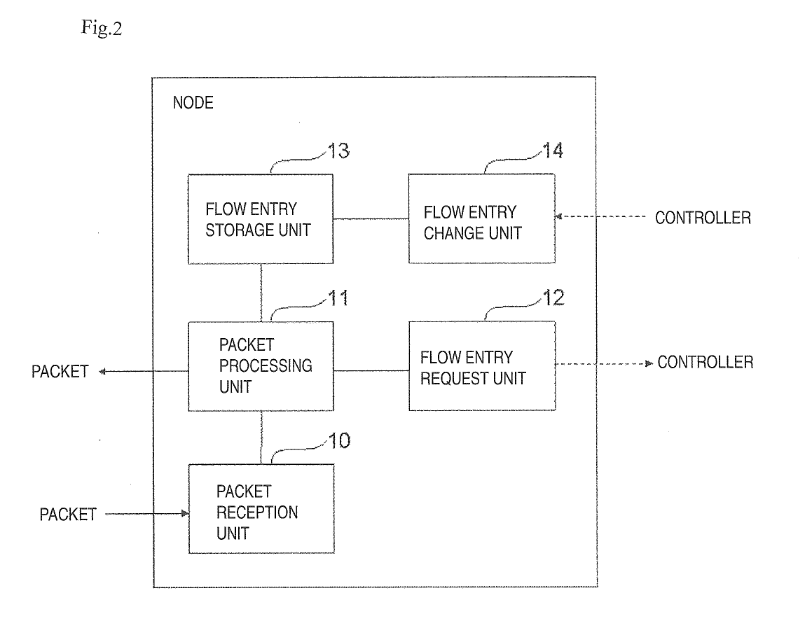

FIG. 2 illustrates a configuration of each of the nodes R1 to R3.

A packet reception means (unit) 10 receives a packet, and a packet processing means (unit) 11 processes the incoming packet in accordance with a flow entry supplied from the controller C1. For example, if no flow entry corresponding to the incoming packet exists, a flow entry request means (unit) 12 requests the controller C1 for a flow entry for processing the incoming packet. A flow entry storage unit 13 stores flow entries. In each of the entries, a process applied to a packet and a matching rule for determining a packet to which the process is applied are associated with each other. A flow entry change means (unit) 14 changes a flow entry in the flow entry storage unit 13, based on a flow entry supplied from the controller C1.

The packet processing means (unit) 11 refers to the flow entry storage unit 13 to search for a flow entry having a matching rule matching the incoming packet received by the packet reception means (unit) 10. If a flow entry corresponding to the incoming packet exists, the packet processing means (unit) 11 processes the incoming packet based on the corresponding flow entry.

If no flow entry corresponding to the incoming packet exists, the flow entry request means (unit) 12 requests the controller C1 to set for a flow entry for processing the incoming packet via a secure channel.

The flow entry change means (unit) 14 stores a flow entry supplied from the controller C1 in the flow entry storage unit 13. The packet processing means (unit) 11 processes the incoming packet in accordance with the flow entry supplied from the controller C1.

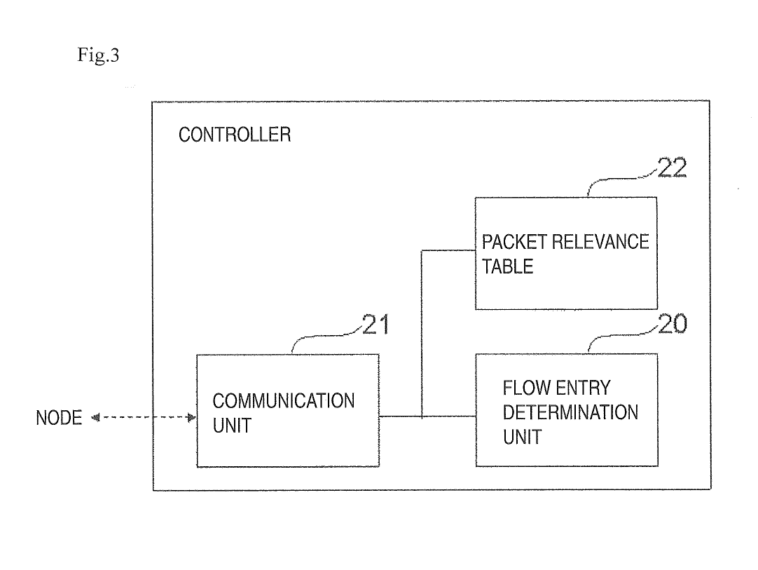

As illustrated in FIG. 3, the controller C1 includes a flow entry determination means (unit) 20. In response to a request from a first node, the flow entry determination means (unit) 20 determines a first flow entry corresponding to a first packet and preliminarily determines a second flow entry corresponding to a second packet that relates to the first packet. In addition, the controller C1 includes a communication means (unit) 21 communicating with a node via a secure channel. In addition, the controller C1 includes a packet relevance table 22 storing information about packets that relate to each other.

For example, in response to a request from the node R1, the flow entry determination means (unit) 20 determines a first flow entry corresponding to a packet P1, which is a packet received by the node R1, and preliminarily determines a second flow entry corresponding to a packet P2 that relates to the packet P1. The flow entry determination means (unit) 20 calculates the entries corresponding to a plurality of related packets in one transaction. For example, a related packet is another packet (second packet) generated by a predetermined packet (first packet).

For example, assuming that a packet transmitted from a terminal is the first packet, a reply packet in response to the packet is the second packet that relates to the first packet. This is because the reply packet is generated by the packet transmitted from the terminal. More specifically, in a protocol such as DNS, ARP, EAP, NTP, or WINS, assuming that a packet transmitted from a terminal is the first packet, a reply packet transmitted from a server is the second packet that relates to the first packet.

For example, assuming that a packet storing data is the first packet, an acknowledgement (ACK) packet for notifying reception of the packet storing data is the second packet that relates to the first packet.

For example, if a terminal accesses a server via an apparatus such as a load balancer, after a packet is transmitted from the terminal to the load balancer, a packet is generated from the load balancer to the server. In this case, assuming that the packet from the terminal to the load balancer is the first packet, the packet from the load balancer to the server is the second packet that relates to the first packet.

The related packets are not limited to the above examples. An arbitrary packet is applicable, as long as another packet is generated by a predetermined packet.

In addition, the number of the related packets is not limited. An arbitrary number of packets may be defined as the related packets. For example, after a server receives a packet from a terminal via a load balancer, if the server communicates with a database, the following first to third packets are the packets that relate to each other: (1) the packet from the terminal to the load balancer is the first packet, (2) the packet from the load balancer to the server is the second packet, and (3) the packet from the server to the database is the third packet.

To determine the packets that relate to each other, the flow entry determination means (unit) 20 may refer to the packet relevance table 22 storing information about the packets that relate to each other.

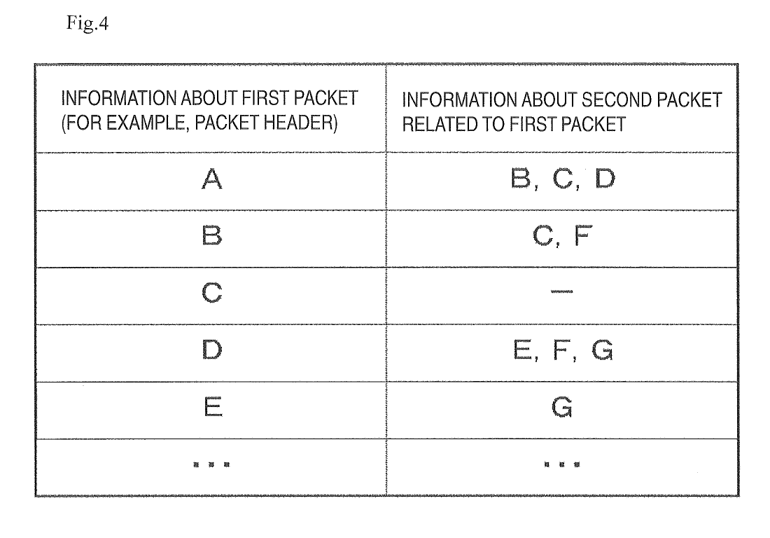

FIG. 4 illustrates a configuration of the packet relevance table 22.

As illustrated in FIG. 4, the packet relevance table 22 stores information about a packet and information about at least one different packet that relates to the packet, these packets being associated with each other. For example, in the packet relevance table 22, a reply packet transmitted from a server is associated with information about a packet transmitted from a terminal.

In FIG. 4, any one of the information A to G represents information about the first or second packet.

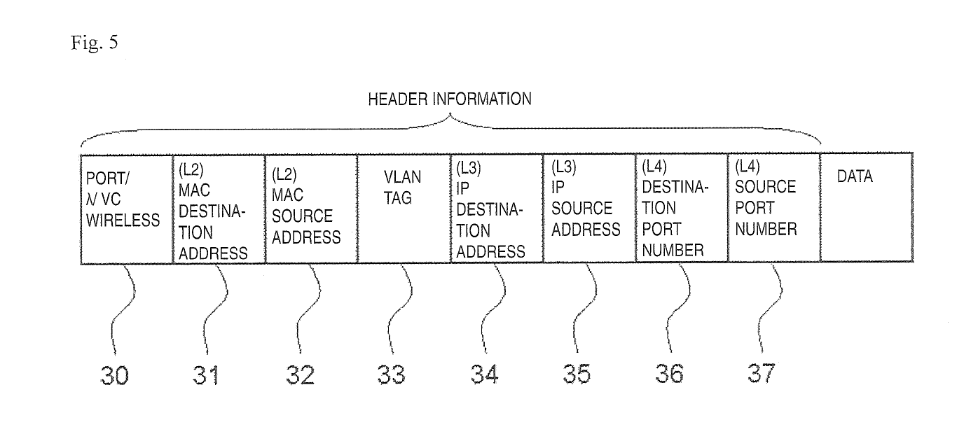

For example, the information A to G represents header information in a packet illustrated in FIG. 5. In this case, for example, in the packet relevance table 22, the header information B to D in the second packets is stored with respect to the header information A about the first packet.

For example, the information A to G may be constituted by part of the header information about the packet illustrated in FIG. 5. More specifically, the information A to G may be constituted by a MAC destination address 31, a MAC source address 32, an IP destination address 34, and an IP source address 35. Needless to say, the information A to G may be constituted by selecting arbitrary elements from the elements 30 to 37 in the packet header information.

For example, the information about the first or second packet represented by A to G may be a packet itself.

The information about the first or second packet represented by A to G is not limited to the above examples. As long as information can identify a packet, arbitrary information may be used.

The packet relevance table 22 may store information about the third packet, as information about a packet that relates to the information about the second packet. The flow entry determination means (unit) 20 can determine that the second and third packets relate to each other, based on the packet relevance table 22. The flow entry determination means (unit) 20 can recognize the first to third packets as the packets that relate to each other and can collectively calculate paths in a single transaction. By repeating this operation, the flow entry determination means (unit) 20 can collectively calculate paths in a single transaction for the packets that relate to each other. The number or type of packets for which collective path calculation can be executed in a single transaction may be arbitrary.

The communication means (unit) 21 in the controller C1 receives a request for a flow entry from at least one node. For example, from the node R1, the communication means (unit) 21 receives a request for a flow entry for processing the packet P1 received by the node R1.

In addition, the communication means (unit) 21 notifies a node of a flow entry determined by the flow entry determination means (unit) 20. Namely, the communication means (unit) 21 notifies the first node of the first flow entry and notifies at least one node of the second flow entry. For example, the communication means (unit) 21 notifies the node R1 of the first flow entry corresponding to the packet P1 and notifies the node R2 of the second flow entry corresponding to the packet P2 that relates to the packet P1.

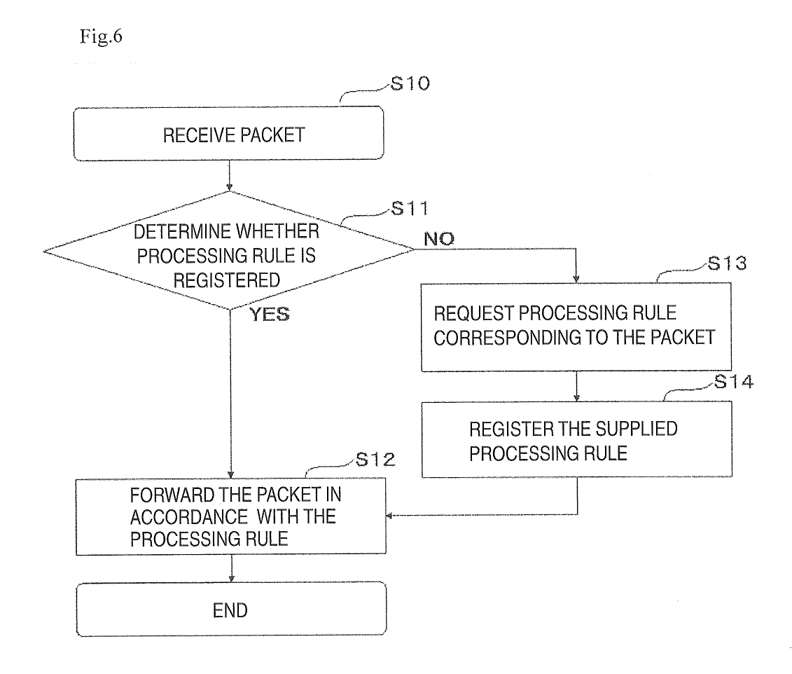

An operation example of the node R3 executed when the node R3 receives a packet according to the first exemplary embodiment will be described with reference to FIG. 6.

In step 11 (S11), the packet processing means (unit) 11 in the node R3 determines whether a flow entry corresponding to an incoming packet is stored in the flow entry storage unit 13.

If the packet processing means (unit) 11 determines that such flow entry is registered, in step 12 (S12), the packet processing means (unit) 11 forwards the packet received by the packet reception means (unit) 10 in accordance with the flow entry.

If the packet processing means (unit) 11 does not determine that such flow entry is registered, in step 13 (S13), the flow entry request means (unit) 12 requests the controller C1 to set a flow entry corresponding to the packet.

In step 14 (S14), the flow entry change means (unit) 14 registers the flow entry supplied from the controller in the flow entry storage unit 13. Next, in step 12 (S12), the packet processing means (unit) 11 forwards the packet received by the packet reception means (unit) 10 in accordance with the flow entry.

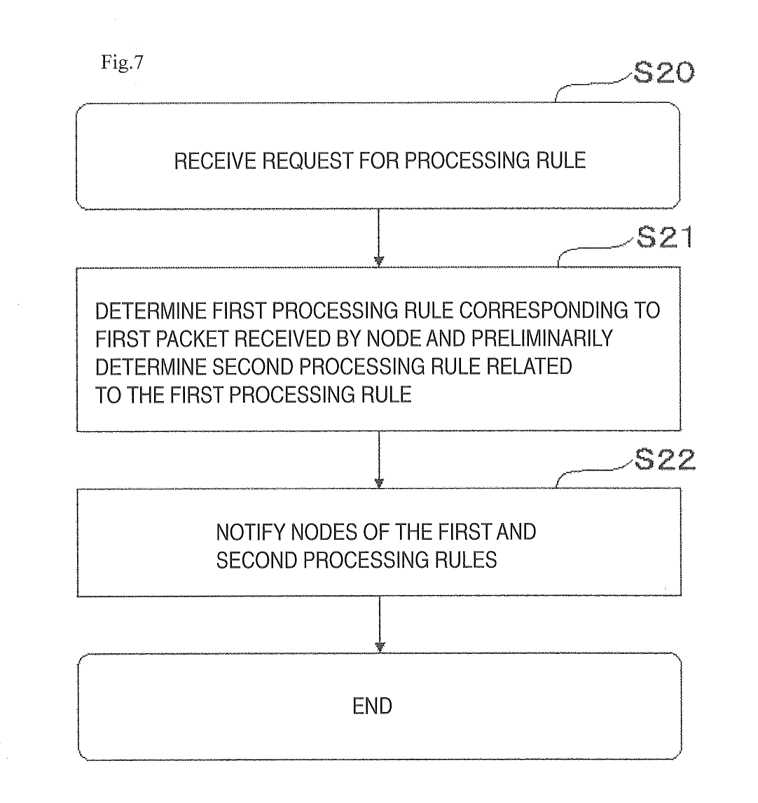

An operation example of the controller C1 executed when the controller C1 receives a request for a flow entry for processing a packet from the node R3 according to the first exemplary embodiment will be described with reference to FIG. 7.

In step 20 (S20), the communication means (unit) 21 in the controller C1 receives a request for a flow entry for processing an incoming packet from the node R3.

In step 21 (S21), in response to the request from the node R3, the flow entry determination means (unit) 20 determines a first flow entry corresponding to the first packet received by the node R3 and preliminarily determines a second flow entry corresponding to a second packet that relates to the first packet.

In step 22 (S22), the communication means (unit) 21 notifies the node R3 of the first flow entry and notifies at least one node of the second flow entry.

As described above, in the first exemplary embodiment, in response to a request from a first node, the controller C1 determines a first flow entry corresponding to a first packet and preliminarily determines a second flow entry corresponding to a second packet that relates to the first packet. Thus, compared with cases where flow entries corresponding to the first and second packets are separately determined, the load on the controller C1 can be reduced.

### Second Exemplary Embodiment

In a second exemplary embodiment, a load balancer that forwards an incoming packet to an appropriate destination is added to the network system according to the first exemplary embodiment.

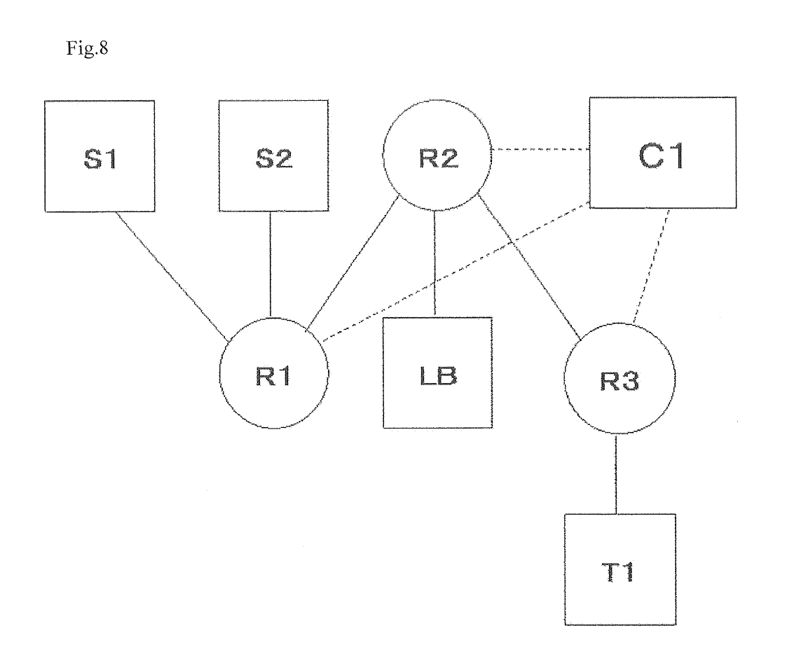

FIG. 8 illustrates a configuration of a network system according to the second exemplary embodiment. The same components as those in the first exemplary embodiment will not be described redundantly.

As illustrated in FIG. 8, the network system according to the second exemplary embodiment includes a terminal T1 connected to the network via at least one of the nodes R1 to R3. In addition, this network system includes servers S1 and S2 exchanging packets with the terminal T1. In addition, the network system includes a load balancer LB that receives a packet and forwards the packet to a suitable server. In the network system illustrated in FIG. 8, the load balancer LB forwards a packet from the terminal T1 to an appropriate server.

The terminal T1 exchanges packets with the server S1 and is connected to the network via at least one of the plurality of nodes R1 to R3. The terminal T1 may be connected to the nodes R1 to R3 in an arbitrary manner including wireless communication, for example.

The terminal T1 transmits a packet addressed to the servers S1 and S2. For example, in response to the packet transmitted from the terminal T1, the servers S1 and S2 transmit a reply packet, to provide a service to the terminal T1.

The load balancer LB receives a packet transmitted from the terminal T1, determines an appropriate destination for the packet, rewrites the MAC address or the like of the packet, and forwards the packet to an appropriate server. In FIG. 8, the load balancer LB forwards the packet from the terminal T1 to either the server S1 or S2.

Each of the nodes R1 to R3 can be connected to the terminal T1 and can receive a packet from the terminal T1. The nodes R1 to R3 have a configuration identical to that according to the first exemplary embodiment.

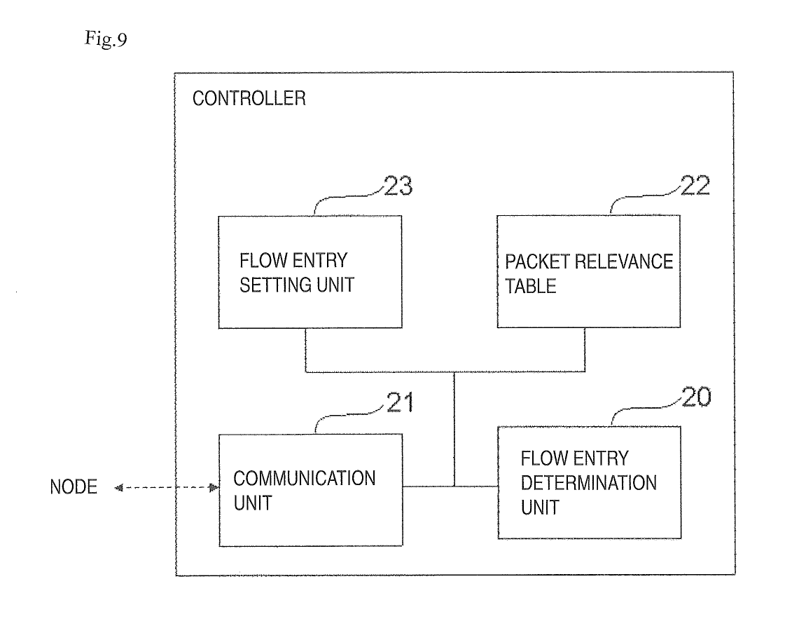

The controller C1 controls packet forwarding paths in response to a request from at least one of the nodes R1 to R3. As illustrated in FIG. 9, the controller C1 includes a flow entry setting means (unit) 23 setting a determined flow entry in nodes. In addition, the controller C1 includes the packet relevance table 22 storing related packets that are associated with each other. The flow entry determination means (unit) 20, the communication means (unit) 21, and the packet relevance table 22 are the same as those according to the first exemplary embodiment.

In FIG. 8, the communication means (unit) 21 receives a request for setting a flow entry for a packet received by the node R3, from the node R3 connected to the terminal T1.

In response to the request received by the communication means (unit) 21, the flow entry determination means (unit) 20 determines a flow entry for processing a first packet and preliminarily determines a flow entry for processing a second packet that relates to the first packet. In FIG. 8, the flow entry determination means (unit) 20 calculates a path for forwarding the packet from the terminal T1 to the load balancer LB as a flow entry for processing the first packet and determines a flow entry for realizing the path. In addition, the flow entry determination means (unit) 20 calculates a path for forwarding the packet from the load balancer LB to the server S1 or S2 as a flow entry for processing the second packet and preliminary determines a flow entry for realizing the path.

When the node R3 receives a packet, it is uncertain whether the load balancer LB actually forwards the packet to the server S1 or S2. Thus, the flow entry determination means (unit) 20 calculates a path for forwarding the packet to the server S1 and a path for forwarding the packet to the server S2 and preliminarily determines flow entries for realizing the paths. In this way, when the load balancer LB determines a server to which the packet is forwarded and forwards the packet, the node R2 can process the packet, without requesting the controller for a flow entry.

For example, the flow entry determination means (unit) 20 calculates a packet path to the server S1 as

LB→R2→R1→S1

and a packet path to the server S2 as

LB→R2→R1→S2

and preliminarily determines flow entries for realizing the paths. Next, the flow entry setting means (unit) 23 sets the preliminarily-determined flow entries in the nodes R2 and R3. Thus, for example, when the load balancer LB determines to forward the packet to the server S1 and forwards the packet addressed to the server S1 to the node R2, the node R2 can forward the packet without requesting the controller C1 for a flow entry.

In the packet relevance table 22, information about the packet from the terminal T1 to the load balancer LB is associated with (1) information about the packet from the load balancer LB to the server S1 and (2) information about the packet from the load balancer LB to the server S2. By referring to the packet relevance table 22, the flow entry determination means (unit) 20 can determine (1) the packet from the load balancer LB to the server S1 and (2) the packet from the load balancer LB to the server S2, as the packets that relate to the packet from the terminal T1 to the load balancer LB.

The flow entry setting means (unit) 23 notifies at least one node of the flow entries for processing the first and second packets, the flow entries having been determined by the flow entry determination means (unit) 20. In FIG. 8, the flow entry setting means (unit) 23 notifies the nodes R3 and R2 of the flow entry for processing the first packet and notifies the nodes R2 and R1 of the flow entry for processing the second packet.

As described above, as a single transaction, the controller C1 collectively calculates paths for the first packet received by the node R3 and for the second packet that relates to the first packet. Thus, compared with cases where the paths are separately calculated for the respective packets, the load on the controller C1 can be reduced.

### Third Exemplary Embodiment

A third exemplary embodiment is based on the first exemplary embodiment. However, according to the third exemplary embodiment, the controller C1 calculates forward and return paths of a packet in response to a request from a node and determines flow entries for realizing the calculated paths.

For example, in a protocol such as DNS, ARP, EAP, NTP, or WINS, a server transmits a reply packet in response to a packet transmitted from a terminal. Thus, setting of a round-trip path is highly needed. In a protocol such as DNS, ARP, EAP, NTP, or WINS, since nodes frequently transmit and receive packets having header information different from each other, the nodes frequently transmit requests for flow entries for such packets.

In such case, by causing the controller C1 to collectively calculate forward and return paths of a packet, the load on the controller can be reduced.

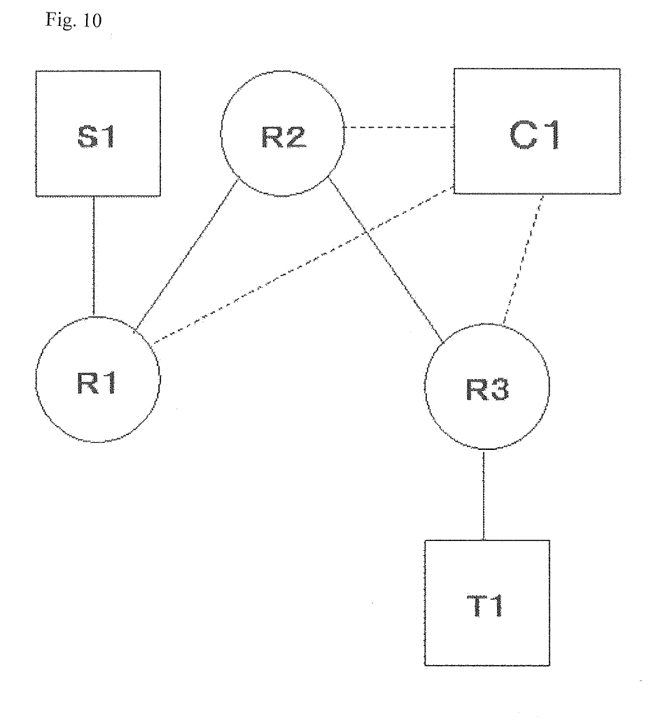

FIG. 10 illustrates a configuration of a network system according to the third exemplary embodiment. As illustrated in FIG.

10, the network system according to the third exemplary embodiment includes: a terminal T1 connected to the network via at least one of the nodes R1 to R3; and a server S1 exchanging packets with the terminal T1.

In the third exemplary embodiment, the configurations of the nodes R1 to R3 and the controller C1 are the same as those according to the second exemplary embodiment.

In response to a request from at least one of the nodes R1 to R3, the flow entry determination means (unit) 20 in the controller C1 calculates (1) a path (forward path) for a packet and (2) a path (return path) for a reply packet in response to the packet and determines flow entries for realizing the calculated paths. Thus, according to the third exemplary embodiment, when receiving a request for a flow entry for processing a packet, the controller C1 calculates forward and return paths for the packet and determines flow entries for realizing the respective paths.

In FIG. 10, in response to a request from the node R3, the flow entry determination means (unit) 20 in the controller C1 calculates (1) a path (forward path) for a packet transmitted from the terminal T1 to the server S1 and (2) a path (return path) for a replay packet transmitted from the server S1 to the terminal T1. For example, the flow entry determination means (unit) 20 calculates

node R3→node R2→node R1

as the packet path and

node R1→node R2→node R3

as the reply packet path. Next, the flow entry setting means (unit) 23 notifies the nodes R3 and R2 of a flow entry for realizing (1) the path packet and notifies the nodes R2 and R1 of a flow entry for realizing (2) the reply packet path.

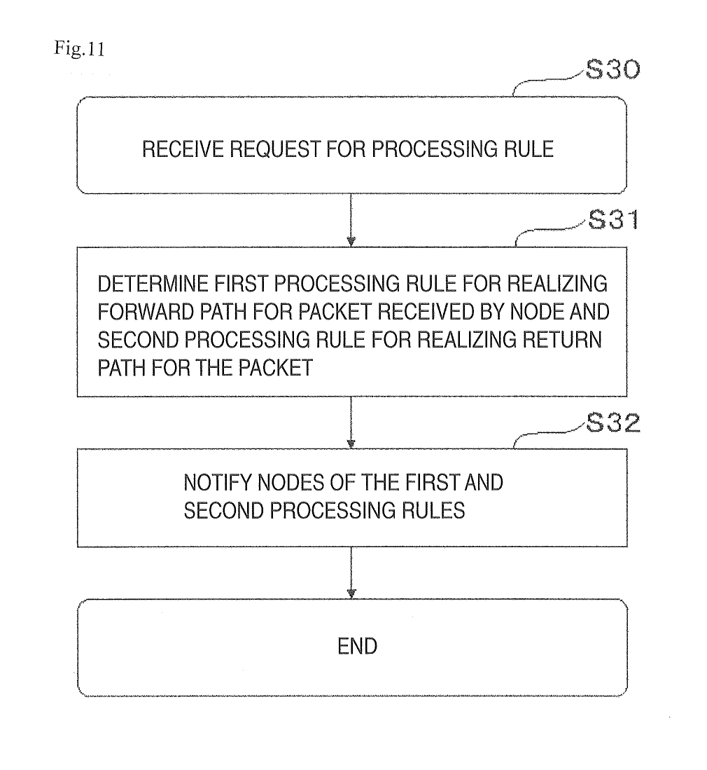

Next, an operation of the controller C1 according to the third exemplary embodiment will be described with reference to FIG. 11. This operation is executed when the controller C1 receives a request for setting a flow entry for a packet from the node R3. The operation of the node R3 is the same as that according to the first exemplary embodiment.

In step 30 (S30), from the node R3 that has received a packet from the terminal T1, the communication means (unit) 21 in the controller C1 receives a request for a flow entry for processing the incoming packet.

In step 31 (S31), the flow entry determination means (unit) 20 calculates (1) a path (forward path) for the packet transmitted from the terminal T1 to the server S1 and (2) a path (return path) for a reply packet transmitted from the server S1 to the terminal T1 and determines flow entries for realizing the calculated paths.

In step 32 (S32), the flow entry setting means (unit) 23 sets the flow entries for realizing the first and second paths (forward and return paths) calculated by the flow entry determination means (unit) 20 in the nodes that relate to the paths.

As described above, since the controller C1 sets the forward and return paths for the packet transmitted from the terminal T1, compared with cases where the paths are calculated separately for the forward and return paths, the load on the controller C1 can be reduced.

The flow entry determination means (unit) 20 may be configured to collectively calculate a path (forward path) for the packet and a path (return path) for a reply packet in response to the packet if the controller C1 receives a request for a flow entry from a node that exists at an end of the network. By limiting cases where the controller sets the forward and return paths, the load on the controller can be reduced. The terminal T1 is connected to a node that exists at an end of the network, for example. Such node that exists at an end of the network serves as a contact point between the network domain managed by the controller C1 and another network domain, for example.

For example, the flow entry determination means (unit) 20 may be configured to collectively calculate a path (forward path) for a packet and a path (return path) for a reply packet in response to the packet, only when the controller C1 receives a request for flow entries from a node that can be connected to the terminal T1.

For example, the flow entry determination means (unit) 20 may be configured to collectively calculate a path (forward path) for a packet and a path (return path) for a reply packet in response to the packet, only when the controller C1 receives a request for flow entries from a node serving as a connection point with another network.

### Fourth Exemplary Embodiment

A fourth exemplary embodiment is based on the third exemplary embodiment. However, according to the fourth exemplary embodiment, a path from each node to the server S1, which is the destination of a packet transmitted from the terminal T1, is set preliminarily.

For each node, the controller preliminarily calculates a flow entry for a path from the node to an apparatus that can serve as the destination of a packet. In this way, when a node actually receives a packet, the controller calculates only a return path for the packet. Thus, the load on the controller can be reduced.

The configuration of a network system according to the fourth exemplary embodiment is the same as that according to the third exemplary embodiment.

The terminal T1 and the server S1 operate in the same way as those according to the third exemplary embodiment.

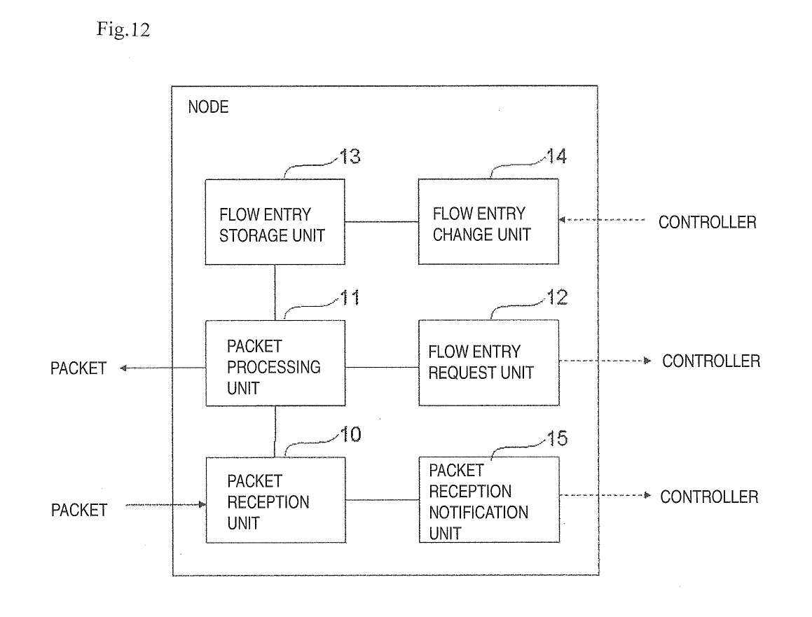

According to the fourth exemplary embodiment, as illustrated in FIG. 12, each of the nodes R1 to R3 includes a packet reception notification means (unit) 15 detecting a packet received by the packet reception means (unit) 10 and transmitting a packet reception notification indicating reception of the packet to the controller C1.

The packet reception notification means (unit) 15 detects a packet received by the packet reception means (unit) 10 and transmits a packet reception notification indicating reception of the packet to the controller C1. For example, when the packet reception means (unit) 10 receives a packet, the packet reception notification means (unit) 15 in the node R3 transmits a packet reception notification about the packet to the controller C1.

The packet reception notification is used to notify the controller C1 that the node has received a packet. Thus, the packet reception notification is different from a request transmitted to request the controller C1 to set a flow entry.

In the fourth exemplary embodiment, when a node receives a packet, a flow entry corresponding to the incoming packet has already been stored in the flow entry storage unit 13 in the node. Thus, the flow entry request means (unit) 12 in the node does not transmit a request for a flow entry for processing the incoming packet to the controller C1. Namely, the controller C1 does not receive a request for a flow entry from the node. Therefore, unlike the third exemplary embodiment, the controller C1 does not calculate a return path for the packet, in response to a request for a flow entry from the node.

According to the fourth exemplary embodiment, the packet reception notification means (unit) 15 in a node transmits a packet reception notification indicating reception of a packet to the controller C1. The controller C1 calculates a return path for the packet, in response to the packet reception notification.

Even if the controller C1 receives the packet reception notification, the controller C1 does not calculate a forward path for the packet. This is because a flow entry for realizing a packet forward path has already been stored in the flow entry storage unit 13 in the node.

The packet reception notification means (unit) 15 may be configured to transmit a packet reception notification based on an action written in a flow entry retrieved by the packet processing means (unit) 11. In this case, an action about forwarding of the packet and an action about transmission of a packet reception notification are defined in the retrieved flow entry. Namely, the flow entry includes a process of transmitting a packet reception notification indicating reception of the incoming packet in accordance with reception of a packet.

A packet reception notification transmitted from the packet reception notification means (unit) 15 includes information about an incoming packet and an identifier of a node transmitting the notification. Examples of the information about the packet include: information about a packet source and a packet destination such as the IP and MAC addresses; and header information such as a port number through which the packet is received and a sequence number. The information about the packet may be the incoming packet itself. Examples of the identifier of the node include the IP and MAC addresses of the node and a router ID given by a network administrator.

The information about the packet and the identifier of the node are not limited to the above examples. Arbitrary information can be used as long as the controller can identify the packet and the node.

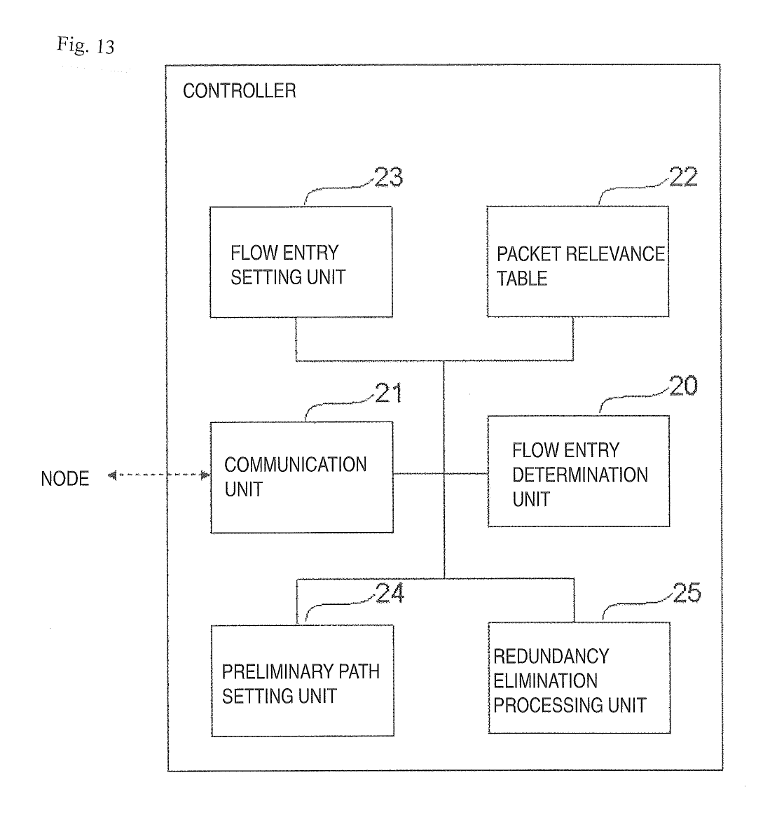

As illustrated in FIG. 13, according to the fourth exemplary embodiment, the controller C1 includes a preliminary path setting means (unit) 24 preliminarily setting a path to the server S1 and a redundancy elimination processing means (unit) 25 preventing transmission of a packet reception notification a plurality of times.

The preliminary path setting means (unit) 24 calculates a path to the server S1 from a node controlled by the controller C1, as a path for a first packet. For example, when the system is activated, the controller C1 sets a flow entry corresponding to a packet transmitted to the server S1 in the nodes R1 to R3. For each of the nodes that can receive a packet to the server S1, the preliminary path setting means (unit) 24 calculates a path from the node to the server S1. Next, the flow entry setting means (unit) 23 in the controller C1 notifies at least one node of a flow entry for realizing the path preliminarily calculated by the preliminary path setting means (unit) 24. Thus, since such flow entry for processing a packet is preliminarily set in each node, when a node receives a packet, the node does not transmit a request for a flow entry. As a result, when the node receives a packet, since the controller C1 does not need to calculate a forward path for the incoming packet, the load on the controller C1 can be reduced.

The redundancy elimination processing means (unit) 25 sets a flow entry in a node that has transmitted a packet reception notification, so that the node does not transmit a packet reception notification again when the node receives a packet having the same header again. In this way, the redundancy elimination processing means (unit) 25 can prevent the packet reception notification means (unit) 15 from transmitting a packet reception notification again for a packet, for which the controller has already received a packet reception notification and set a return path.

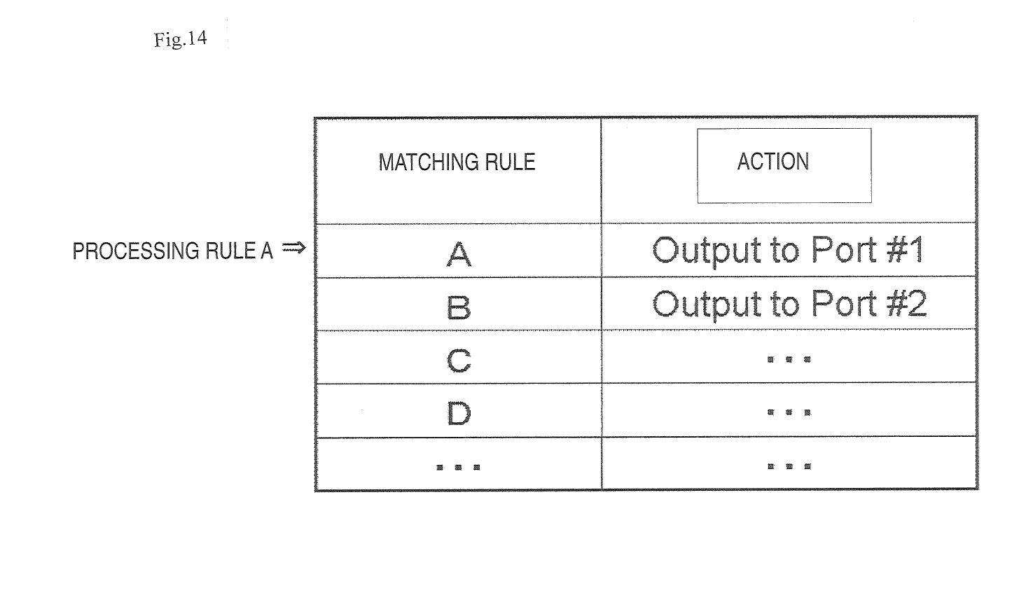

Based on the OpenFlow technique, as illustrated in FIG. 14, the flow entry storage unit 13 in a node stores a flow table storing flow entries, for example. The packet processing means (unit) 11 searches the flow table for a flow entry having a matching rule matching header information of an incoming packet. This search is executed sequentially from the first entry (namely, sequentially from a flow entry A in FIG. 14). If a flow entry having a suitable matching rule is found, the packet processing means (unit) 11 stops this search operation and processes the incoming packet based on an action written in the flow entry. Namely, if the incoming packet matches a higher entry in the flow table, the packet processing means (unit) 11 does not search the subsequent flow entries listed after the higher entry. Thus, a flow entry having a higher priority is set in a higher position in the flow table.

The redundancy elimination processing means (unit) 25 sets a flow entry having a priority higher than that of a flow entry in which transmission of a packet reception notification is written and indicating a process about packet forwarding corresponding to a packet reception notification in a node that has transmitted a packet reception notification. Namely, the redundancy elimination processing means (unit) 25 sets a flow entry, which indicates a process about packet forwarding corresponding to a packet reception notification, in a position higher than a flow entry in which transmission of a packet reception notification is written in the flow table of a node that has transmitted a packet reception notification.

Alternatively, the redundancy elimination processing means (unit) 25 may delete a flow entry in which transmission of a packet reception notification is written from a node that has transmitted a packet reception notification and register a flow entry indicating a process about packet forwarding corresponding to packet reception notification.

As described above, the redundancy elimination processing means (unit) 25 sets a flow entry in a node that has transmitted a packet reception notification, so that the node does not transmit a packet reception notification again when the node receives a packet having the same header again. Thus, even if a node receives a packet having the same header a plurality of times, since the node does not transmit a packet reception notification a plurality of times, the load on the controller C1 receiving such reception notification can be reduced.

Based on a packet reception notification transmitted from at least one of the nodes R1 to R3, the flow entry determination means (unit) 20 sets a flow entry for realizing a path for a reply packet to the packet. For example, the controller C1 calculates a path from the server S1 to the terminal T1 and determines a flow entry for realizing the calculated path. More specifically, the flow entry determination means (unit) 20 is notified of a packet reception notification by the node R3, calculates a path as a path for a reply packet from the server S1 as the packet destination to the terminal T1 as the packet source, and determines a flow entry for realizing the path.

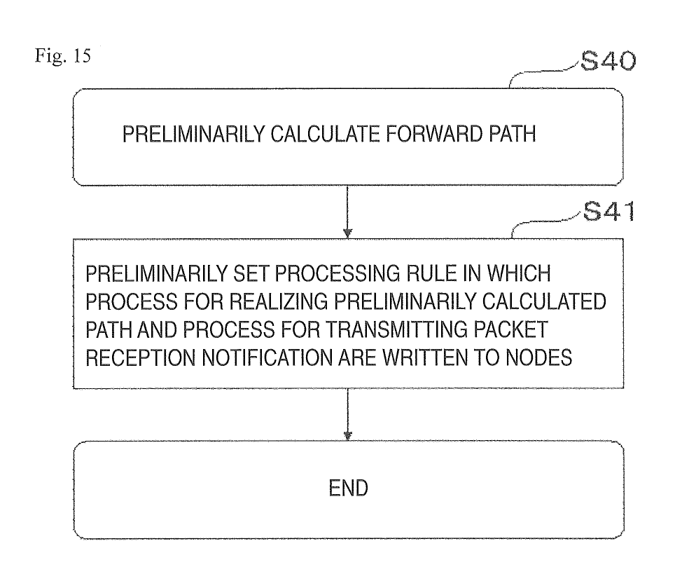

Next, a flow path control process according to the fourth exemplary embodiment will be described in detail. FIG. 15 illustrates an operation of the controller for preliminarily setting a path.

In step 40 (S40), the preliminary path setting means (unit) 24 preliminarily calculates a path from each of the nodes R1 and R3, which can receive a packet addressed to the server S1, to the server S1. If a plurality of apparatuses can be packet destinations such as the server S1 (namely, apparatuses as packet destination candidates), the preliminary path setting means (unit) 24 calculates the paths from each node to each of the plurality of apparatuses.

In step 41 (S41), the flow entry setting means (unit) 23 in the controller C1 sets a flow entry in each node. The flow entry indicates a process for realizing a packet path to the server S1 and a process for transmitting a packet reception notification to the controller C1 when the node receives a packet addressed to the server S1. By setting such flow entry, when the node receives a packet addressed to the server S1, the controller C1 is notified of a packet reception notification.

The flow entry for transmitting a packet reception notification may be set in a node located at a position where a packet is highly likely to be newly transmitted into the OpenFlow network, such as a node corresponding to a connection node with another network or a node connected to a terminal. In this way, since a packet reception notification is transmitted from a node through which a packet is highly likely to be newly transmitted, the load on the controller C1 can be reduced.

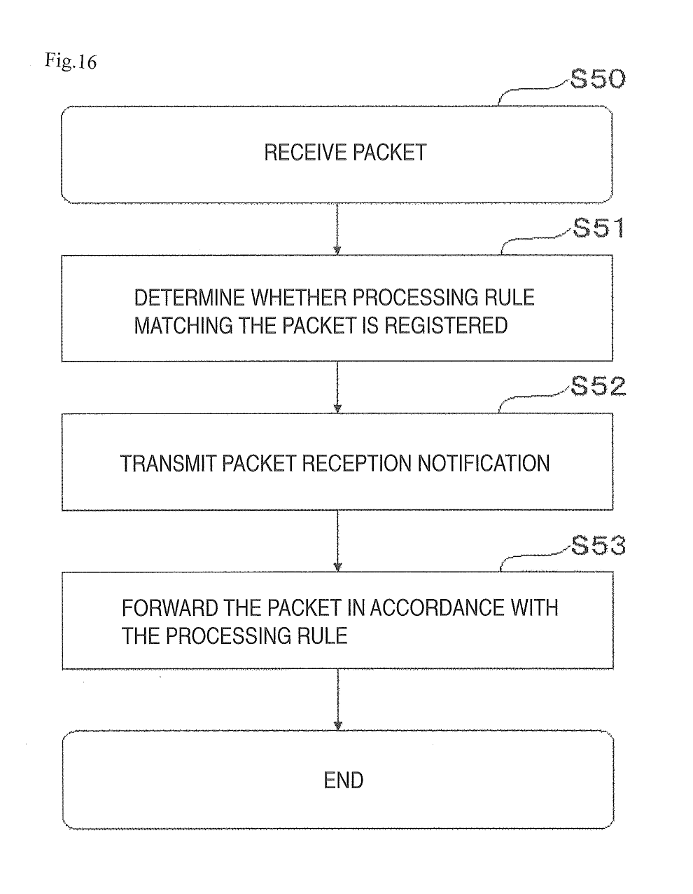

Next, an operation of the node R3 according to the fourth exemplary embodiment will be described with reference to FIG. 16. This operation is executed when the node R3 receives a packet from the terminal T1.

In step 50 (S50), the node R3 receives a packet from the terminal T1.

After receiving a packet, in step 51 (S51), the packet processing means (unit) 11 in the node searches for a flow entry having a matching rule matching header information of the packet.

According to the fourth exemplary embodiment, since a flow entry is preliminarily registered, in step 52 (S52), the node transmits a packet reception notification indicating reception of the packet to the controller C1. For example, if a path for a packet addressed to the server S1 is preliminarily set, the packet processing means (unit) 11 finds a flow entry preliminarily set, as a result of the search. In this case, the packet reception notification means (unit) 15 in the node R3 transmits the packet reception notification about the packet to the controller C1.

In step 53 (S53), the packet processing means (unit) 11 forwards the packet received by the packet reception means (unit) 10 in accordance with the flow entry.

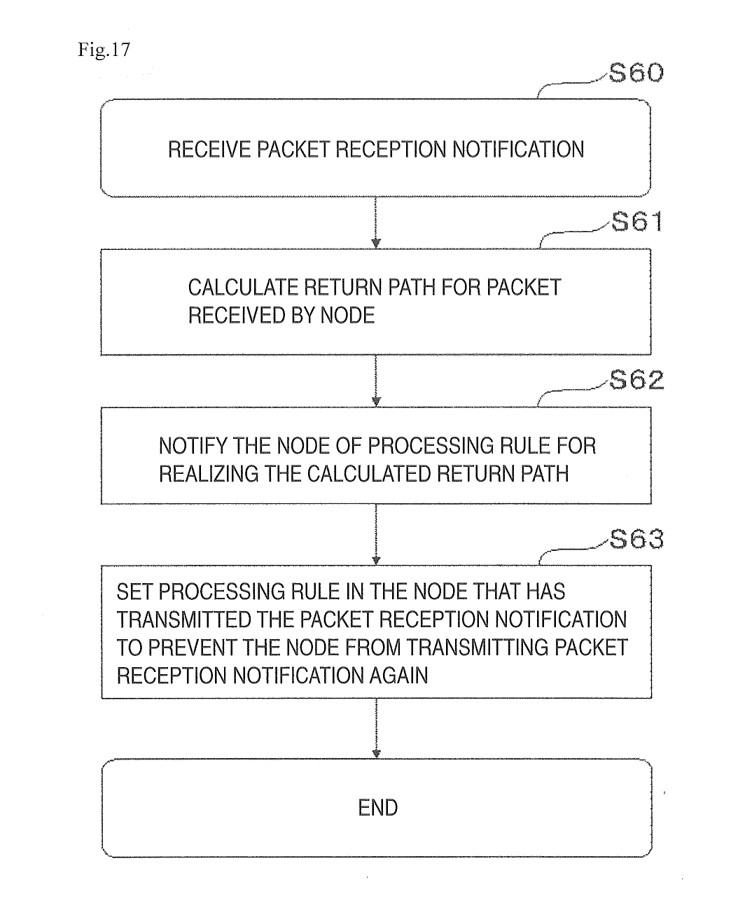

An operation of the controller C1 according to the fourth exemplary embodiment will be described with reference to FIG. 17. This operation is executed when the controller C1 receives a packet reception notification from the node R3.

In step 60 (S60), the communication means (unit) 21 in the controller C1 receives a packet reception notification, which indicates that the node R3 has received a packet from the terminal T1, from the node R3.

In step 61 (S61), based on this packet reception notification, the flow entry determination means (unit) 20 calculates a path for a reply packet to the packet, namely, a return path.

The flow entry determination means (unit) 20 in the controller C1 may be configured to determine whether the communication means (unit) 21 has received a packet reception notification or a request for setting a flow entry. If the flow entry determination means (unit) 20 determines reception of a packet reception notification, based on the supplied information, the flow entry determination means (unit) 20 calculates a path from the server S1 to the terminal T1 (namely, a return path). As the path from the server S1 to the terminal T1, an appropriate path may be calculated each time or selected from the paths preliminarily calculated. If the flow entry determination means (unit) 20 determines a request for setting a flow entry, the flow entry determination means (unit) 20 calculates a path from the node to the server S1 (namely, a forward path of the packet) and a path from the server S1 to the terminal T1 (namely, a return path of the packet).

In step 62 (S62), the flow entry setting means (unit) 23 sets the path calculated by the flow entry determination means (unit) 20 in the nodes that relate to the calculated path.

In step 63 (S63), the redundancy elimination processing means (unit) 25 sets a flow entry in the nodes so that the nodes do not transmit a packet reception notification again for a packet for which a packet reception notification has already been transmitted.

As described above, since paths from each of the node to the server S1 are preliminarily set, if the node R3 actually receives a packet, the controller C1 calculates only a path for a packet from the server S1 to the node R3 (return path). Thus, the load on the controller C1 can be reduced.

In addition, preferably, the following modes are possible.

### (Mode 1)

There is provided the communication system according to the above first aspect.

### (Mode 2)

It is preferable that the control apparatus comprise:

a storage unit associating information about the first packet with information about the second packet that relates to the first packet and storing the information about the first and second packets; and

a means (unit) referring to the storage unit to determine that the first and second packets relate to each other.

### (Mode 3)

It is preferable that the first means (unit) determine a processing rule corresponding to a path for forwarding the second packet from a destination of the first packet to a source of the first packet, as the second processing rule.

### (Mode 4)

It is preferable that the first means (unit) preliminarily determine the first processing rule and that the second means (unit) notify at least one of the plurality of nodes of the first processing rule.

### (Mode 5)

It is preferable that at least one of the plurality of nodes comprise a means (unit) transmitting a reception notification indicating reception of the first packet to the control apparatus when receiving the first packet and that the first means (unit) determine the second processing rule in response to the reception notification.

### (Mode 6)

It is preferable that the first means (unit) preliminarily determine a third processing rule defining transmission of the reception notification to the control apparatus when receiving the first packet and that the second means (unit) notify at least one of the plurality of nodes of the third processing rule.

### (Mode 7)

It is preferable that, when receiving the packet reception notification corresponding to the first packet, the first means (unit) instruct a node that has transmitted the packet reception notification to prevent transmission of the packet reception notification corresponding to the first packet.

### (Mode 8)

There is provided the control apparatus according to the above second aspect.

### (Mode 9)

It is preferable that the control apparatus comprise:

a storage unit associating information about the first packet with information about the second packet that relates to the first packet and storing the information about the first and second packets; and

a means (unit) referring to the storage unit to determine that the first and second packets relate to each other.

### (Mode 10)

It is preferable that the first means (unit) determine a processing rule corresponding to a path for forwarding the second packet from a destination of the first packet to a source of the first packet, as the second processing rule.

### (Mode 11)

It is preferable that the first means (unit) preliminarily determine the first processing rule and that the second means (unit) notify at least one of the plurality of nodes of the first processing rule.

### (Mode 12)

It is preferable that the control apparatus comprise a means (unit) receiving a reception notification indicating reception of the first packet from at least one of the plurality of nodes and that the first means (unit) determine the second processing rule in response to the reception notification.

### (Mode 13)

It is preferable that the first means (unit) preliminarily determine a third processing rule defining transmission of the reception notification to the control apparatus when receiving the first packet and that the second means (unit) notify at least one of the plurality of nodes of the third processing rule.

### (Mode 14)

It is preferable that, when receiving the packet reception notification corresponding to the first packet, the first means (unit) instruct a node that has transmitted the packet reception notification to prevent transmission of the packet reception notification corresponding to the first packet.

### (Mode 15)

There is provided the control method according to the above third aspect.

### (Mode 16)

It is preferable that the control method comprise a step of determining that the first and second packets relate to each other, based on information about the first packet and information about the second packet that relates to the first packet.

### (Mode 17)

It is preferable that the control method comprise a step of

determining a processing rule corresponding to a path for forwarding the second packet from a destination of the first packet to a source of the first packet, as the second processing rule.

### (Mode 18)

It is preferable that the control method comprise steps of:

preliminarily determining the first processing rule; and

notifying at least one of the plurality of nodes of the first processing rule.

### (Mode 19)

It is preferable that the control method comprise steps of:

receiving a reception notification indicating reception of the first packet from at least one of the plurality of nodes; and

determining the second processing rule in response to the reception notification.

### (Mode 20)

It is preferable that the control method comprise steps of:

preliminarily determining a third processing rule defining transmission of the reception notification to the control apparatus when receiving the first packet; and

notifying at least one of the plurality of nodes of the third processing rule.

### (Mode 21)

It is preferable that the control method comprise a step of:

instructing, when receiving the packet reception notification corresponding to the first packet, a node that has transmitted the packet reception notification to prevent transmission of the packet reception notification corresponding to the first packet.

The entire disclosure of related literature such as the above PTL is incorporated herein by reference thereto.

While suitable exemplary embodiments of the present disclosure have thus been described, the present invention is not limited to the above exemplary embodiments.

Modifications and adjustments of the exemplary embodiments are possible within the scope of the overall disclosure (including the claims) of the present invention and based on the basic technical concept of the present invention. Various combinations and selections of various disclosed elements (including the elements in each of the claims, exemplary embodiments, drawings, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

### Reference Signs List

10 packet reception means (unit)
11 packet processing means (unit)
12 flow entry request means (unit)
13 flow entry storage unit
14 flow entry change means (unit)
15 packet reception notification means (unit)
20 flow entry determination means (unit)
21 communication means (unit)
22 packet relevance table
23 flow entry setting means (unit)
24 preliminary path setting means (unit)
25 redundancy elimination processing means (unit)

What is claimed is:

1. A communication system, comprising:
a plurality of nodes;
a first node transmitting a request for a processing rule for processing a first packet; and
a control apparatus comprising a first unit determining a first processing rule corresponding to the first packet in response to the request and preliminarily determining a second processing rule corresponding to a second packet that relates to the first packet and a second unit notifying the first node of the first processing rule and notifying at least one of the plurality of nodes of the second processing rule.

2. The communication system according to claim 1;
wherein the control apparatus comprises:
a storage unit associating information about the first packet with information about the second packet that relates to the first packet and storing the information about the first and second packets; and
a unit referring to the storage unit to determine that the first and second packets relate to each other.

3. The communication system according to claim 1;
wherein the first unit determines a processing rule corresponding to a path for forwarding the second packet from a destination of the first packet to a source of the first packet, as the second processing rule.

4. The communication system according to claim 1;
wherein the first unit preliminarily determines the first processing rule, and the second unit notifies at least one of the plurality of nodes of the first processing rule.

5. The communication system according to claim 4;
wherein at least one of the plurality of nodes comprises a unit transmitting a reception notification indicating reception of the first packet to the control apparatus when receiving the first packet, and the first unit determines the second processing rule in response to the reception notification.

6. The communication system according to claim 5;
wherein the first unit preliminarily determines a third processing rule defining transmission of the reception notification to the control apparatus when receiving the first packet, and the second unit notifies at least one of the plurality of nodes of the third processing rule.

7. The communication system according to claim 6;
wherein, when receiving the packet reception notification corresponding to the first packet, the first unit instructs a node that has transmitted the packet reception notification to prevent transmission of the packet reception notification corresponding to the first packet.

8. A control apparatus, connected to a plurality of nodes, the control apparatus comprising:
a unit receiving a request for a processing rule for processing a first packet from a first node;
a first unit determining a first processing rule corresponding to the first packet in response to the request and preliminarily determining a second processing rule corresponding to a second packet that relates to the first packet; and
a second unit notifying the first node of the first processing rule and notifying at least one of the plurality of nodes of the second processing rule.

9. The control apparatus according to claim 8, further comprising:
a storage unit associating information about the first packet with information about the second packet that relates to the first packet and storing the information about the first and second packets; and
a unit referring to the storage unit to determine that the first and second packets relate to each other.

10. The control apparatus according to claim 8;
wherein the first unit determines a processing rule corresponding to a path for forwarding the second packet from a destination of the first packet to a source of the first packet, as the second processing rule.

11. The control apparatus according to claim 8;
wherein the first unit preliminarily determines the first processing rule, and the second unit notifies at least one of the plurality of nodes of the first processing rule.

12. The control apparatus according to claim 11, further comprising:
a unit receiving a reception notification indicating reception of the first packet from at least one of the plurality of nodes, and the first unit determines the second processing rule in response to the reception notification.

13. The control apparatus according to claim 12;
wherein the first unit preliminarily determines a third processing rule defining transmission of the reception notification to the control apparatus when receiving the first packet, and the second unit notifies at least one of the plurality of nodes of the third processing rule.

14. The control apparatus according to claim 13;
wherein, when receiving the packet reception notification corresponding to the first packet, the first unit instructs a node that has transmitted the packet reception notification to prevent transmission of the packet reception notification corresponding to the first packet.

15. A control method, executed by a control apparatus connected to a plurality of nodes, the control method comprising:
receiving a request for a processing rule for processing a first packet from a first node;
determining a first processing rule corresponding to the first packet in response to the request and preliminarily determining a second processing rule corresponding to a second packet that relates to the first packet; and
notifying the first node of the first processing rule and notifying at least one of the plurality of nodes of the second processing rule.

16. The control method according to claim 15, further comprising:
determining that the first and second packets relate to each other, based on information about the first packet and information about the second packet that relates to the first packet.

17. The control method according to claim 15, further comprising:
determining a processing rule corresponding to a path for forwarding the second packet from a destination of the first packet to a source of the first packet, as the second processing rule.

18. The control method according to claim 15, further comprising:
preliminarily determining the first processing rule; and
notifying at least one of the plurality of nodes of the first processing rule.

19. The control method according to claim 18, further comprising:
receiving a reception notification indicating reception of the first packet from at least one of the plurality of nodes; and
determining the second processing rule in response to the reception notification.

20. The control method according to claim 19, further comprising:
preliminarily determining a third processing rule defining transmission of the reception notification to the control apparatus when receiving the first packet; and
notifying at least one of the plurality of nodes of the third processing rule.

21. The control method according to claim 20, further comprising:
instructing, when receiving the packet reception notification corresponding to the first packet, a node that has transmitted the packet reception notification to prevent transmission of the packet reception notification corresponding to the first packet.
